(19) United States
(12) Patent Application Publication
(10) Pub. No.: US 2012/0229661 A1
(43) Pub. Date: Sep. 13, 2012

(54) PHOTOGRAPHY LENS, PHOTOGRAPHING APPARATUS, PHOTOGRAPHING SYSTEM, IMAGE CAPTURING APPARATUS, AND PERSONAL APPARATUS

(75) Inventors: Masakazu SEKIGUCHI, Kawasaki-shi (JP); Toshiaki MAEDA, Yokohama-shi (JP); Toshikazu MORIKAWA, Yamato-shi (JP); Hisashi SANO, Yokohama-shi (JP); Misa KAWAMURA, Ebina-shi (JP)

(73) Assignee: NIKON CORPORATION, Tokyo (JP)

(21) Appl. No.: 13/481,205

(22) Filed: May 25, 2012

Related U.S. Application Data
(63) Continuation of application No. PCT/JP2010/006811, filed on Nov. 19, 2010.

(30) Foreign Application Priority Data
Dec. 28, 2009 (JP) 2009-298731
Dec. 28, 2009 (JP) 2009-298732
Dec. 28, 2009 (JP) 2009-298733
Dec. 28, 2009 (JP) 2009-298734

(51) Int. Cl. H04N 5/232; H04N 5/228; G03B 17/00; H04N 5/225

(52) U.S. Cl. 348/208.4; 348/207.99; 348/335; 348/345; 348/220.1; 348/372; 348/231.2; 396/439; 348/E05.024; 348/E05.031; 348/E05.028

(57) ABSTRACT

Conventional apparatuses did not pay enough attention to assisting operations when the user is in a state differing from the normal, state. Therefore, provided is a photography lens that comprises a first biometric detection apparatus that is capable of detecting change in biometric information of a photographer, or a photographing apparatus that captures an image and comprises a holding section, an operating section for performing an image capturing operation, and a second biometric detection apparatus that is capable of detecting change in biometric information of a photographer and that is disposed in at least one of the holding section and the operating section.

The Contents of the following Japanese patent applications are incorporated herein by reference:
NO. 2009-298731 filed on Dec. 28, 2009,
NO. 2009-298732 filed on Dec. 28, 2009,
NO. 2009-298733 filed on Dec. 28, 2009, and
NO. 2009-298734 filed on Dec. 28, 2009,

### TECHNICAL FIELD

The present invention relates to a photography lens, a photographing apparatus, a photographing system, an image capturing apparatus, and a personal apparatus.

### BACKGROUND ART

Recently, there have been proposed techniques for detecting a biological state of a photographer, capturing a bright image when the photographer is happy, and capturing a dark image when the photographer is sad.

Patent Document 1: Japanese Patent Application Publication No. 2008-124885

Patent Document 2: Japanese Patent Application Publication No. 2009-105795

### DISCLOSURE OF THE INVENTION

### Problems to be Solved by the Invention

However, in conventional apparatuses, there has been insufficient attention paid to assisting operations when the user is in a state differing from the normal state.

### Means for Solving the Problems

A photography lens of the present invention comprises a first biometric detection apparatus that is capable of detecting change in biometric information of a photographer.

A photographing apparatus of the present invention captures an image, and comprises a holding section that holds the photographing apparatus; an operating section for performing an image capturing operation; and a second biometric detection apparatus that is capable of detecting change in biometric information of a photographer and that is disposed in at least one of the holding section and the operating section.

A photographing system of the present invention comprises a first biometric detection apparatus that is disposed in a photography lens and is capable of detecting change in biometric information of a photographer; a second biometric detection apparatus that is disposed in a photographing apparatus body and capable of detecting change in the biometric information of the photographer; and a detection apparatus that is disposed in the photographing apparatus body and detects change in the biometric information of the photographer based on the detection results of the first and second biometric detection apparatuses.

A photographing apparatus of the present invention comprises a photographing section that captures an image using a photography lens; a setting section that performs setting relating to the image capturing; and a control section that changes at least a portion of a state of the photographing section and the setting of the setting section when the photographing section performs image capturing based on biometric information of a photographer,

An image capturing apparatus of the present invention comprises an image capturing section that is capable of capturing a moving image and a still image; and a control section that is connected to a detection apparatus for detecting camera shake, performs a first camera shake control corresponding to the moving image, and performs a second camera shake control, which differs from the first camera shake control, corresponding to the still image. The control section changes between the first camera shake control and the second camera shake control according to change in biometric information of a photographer detected by a biosensor.

An image capturing apparatus of the present invention comprises an image capturing section that is capable of capturing a moving image and a still image using an optical system; and a control section that is connected to a detection apparatus for detecting camera shake. The control section performs camera shake control by using a first correcting section that corrects camera shake using a portion of the optical system together with a second correcting section that differs from the first correcting section, according to change in biometric information of a photographer detected by a biosensor.

An image capturing apparatus of the present invention comprises an image capturing section that captures an image; a changing section that is capable of changing a setting of a detection apparatus for detecting camera shake; and a control section that changes the setting of the detection apparatus by controlling the changing section, according to change in biometric information of a photographer detected by a biosensor.

An image capturing apparatus of the present invention comprises an image capturing section that captures an image; and a control section that is connected to a detection apparatus for detecting camera shake. The control section corrects camera shake detected by the detection apparatus to have an amplitude exceeding a prescribed value, according to change in biometric information of a photographer detected by a biosensor.

A personal device of the present invention comprises an operating section that is operated by a user; and a prohibiting section that prohibits execution of a portion of the operation performed on the operating section, when a change in biometric information of the user is detected by a biosensor.

### BRIEF DESCRIPTION OF THE DRAWINGS

FIG. 1 shows schematically shows the camera system, according to an embodiment.

FIG. 2 shows the camera system as seen from above, according to an embodiment.

FIG. 3 shows a state in which the photography lens is held by the left hand, according to an embodiment.

FIG. 4 shows a state in which the photography lens is held by the left hand, according to an embodiment.

FIG. 5 shows a biometric information detecting section disposed in the camera body, according to an embodiment.

FIG. 6 shows a configuration of the biometric information detecting section disposed in the camera body, according to an embodiment.

FIG. 7 is a block diagram of the camera system, according to an embodiment.

FIG. 8 is a flow chart of a process for detecting biometric information of the photographer and setting image capturing conditions, according to an embodiment.

### BEST MODE FOR CARRYING OUT THE INVENTION

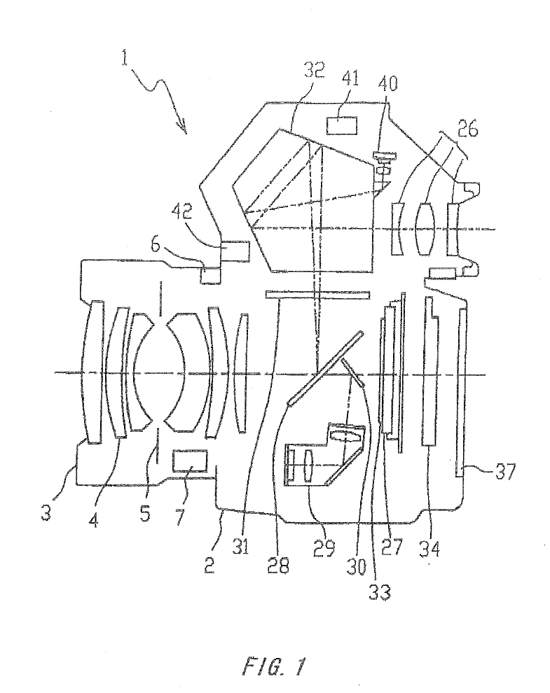

The following describes a camera system according to an embodiment of the present invention, with reference to the drawings. FIG. 1 schematically shows the camera system according to the present embodiment, and the camera system is a single-lens reflex camera system with a replaceable lens.

The camera system 1 includes a camera body 2 and a replaceable photography lens 3. The photography lens 3 includes a lens group 4, which has a focus lens, a zoom lens, and an image-stabilizing lens, a diaphragm 5, a drive apparatus, not shown, that drives the lens group 4, and an angular velocity sensor 6 for detecting camera shake of the camera system 1. The angular velocity sensor 6 includes a gyro sensor that detects vibration on two axes. The drive apparatus, not shown, includes a plurality of motors, such as oscillating wave motors and VCMs, drives the focus lens in a direction of the optical axis, and drives the image-stabilizing lens in a different direction than the optical axis direction. The photography lens 3 controls the overall photography lens 3, and includes a lens CPU 7 that operates together with the camera body 2.

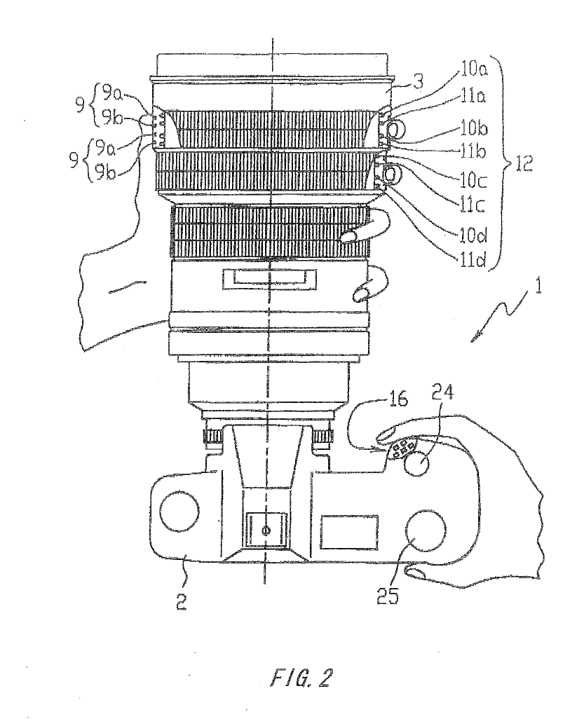

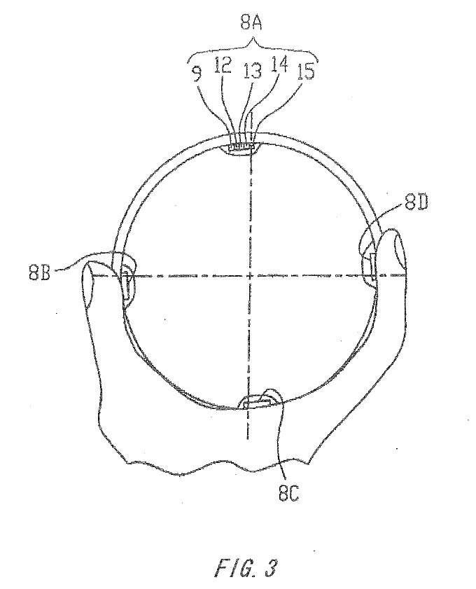

FIG. 2 shows the camera system 1 as seen from above, in a state in which the camera body 2 is held in the right hand of an operator and the photography lens 3 is held in the left hand of the operator. As shown in FIG. 2, the photography lens 3 includes lens-side biosensor sections 8 (8A to 8D) (see FIGS. 3, 4, and 7) that detect the pressure with which the photography lens 3 is held, body temperature, amount of sweat, blood pressure, blood flow, or heart rate of the photographer, for example, at a position where a finger or the palm of the right hand of the photographer touches the lens-side biosensor sections 8. The lens-side biosensor sections 8 include a plurality of electrode sections 9 (reference electrodes 9a and detection electrodes 9b) distanced from each other and a pulse detection apparatus 12 that detects the pulse and includes a plurality of light emitting sections 10a to 10d and a plurality of light receiving sections 11a to 11d. The pulse detection apparatus 12 is used to measure the blood flow and blood pressure of the photographer as described further below, and the light emitting sections 10a to 10d and light receiving sections 11a to lid arc arranged in an alternating mariner as shown in FIG. 2.

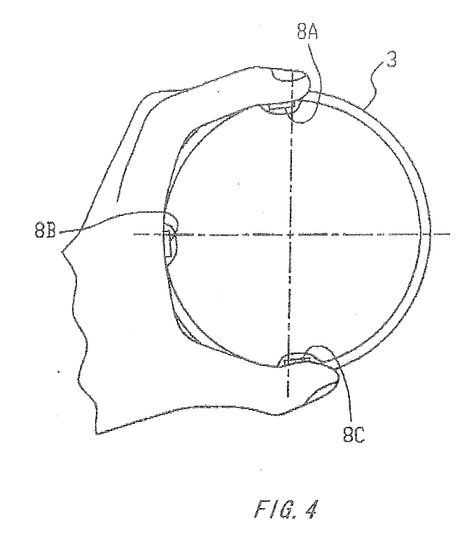

Furthermore, the lens-side biosensor sections 8 include sweat sensors 13 that detect the amount of sweat of the photographer, temperature sensors 14 that detect the body temperature of the photographer, and pressure sensors 15 that detect the pressure with which the photographer holds the photography lens 3 (see FIGS. 3 and 4). When the photographer holds the photography lens 3 and performs a zoom or manual focus operation, fingers on the left hand of the photographer become distanced from other fingers. Therefore, the lens-side biosensor sections 8 are disposed at least at one of a zoom operation position and a manual focus operation position, and are disposed apart from each other at a position corresponding to the thumb of the left hand and a position corresponding to a finger other than the thumb. More specifically, the lens-side biosensor sections 8 are disposed at positions where zoom operation rubber or focus operation rubber is disposed, and are disposed in a manner to contact the left hand or face the left hand.

FIGS. 3 and 4 show states in which the photography lens 3 is held in the left hand. FIG. 3 shows a state in which the photography lens 3 is held with the back of the left hand facing downward, and FIG. 4 shows a state in which the photography lens 3 is held with the back of the left hand facing the left side. The way in which the photography lens 3 is held changes depending on the photographer and the photographing state, e.g. horizontal photographing or vertical photographing, and therefore the lens-side biosensor sections 8 (8A to 8D) are disposed along the circumference of the photography lens 3. The lens-side biosensor sections 8B to 8D each include a plurality of electrode sections 9, a pulse detection apparatus 12, a sweat sensor 13, a temperature sensor 14, and a pressure sensor 15, in the same manner as the lens-side biosensor section 8A. By disposing the lens-side biosensor sections 8 (8A to 8D) along the circumference of the photography lens 3 in this way, the biometric information can also be detected from the palm of the left hand. As described above, in the present embodiment, the lens-side biosensor sections 8 (8A to 8D) arc disposed according to the zoom operation position and the manual focus operation position, but the lens-side biosensors may he provided at different positions, as long as the positions enable detection of biometric information even when the method of holding the photography lens 3 is changed due to the photographer or the image capturing state.

Since the force exerted by the thumb of the left hand when holding the photography lens 3 is not very large, the lens-side biosensor sections 8B and 8C need not include pressure sensors 15 corresponding to the thumb of the left hand. Similarly, if there is no need for the lens-side biosensor sections 8 to have high detection sensitivity, the number of components in the photography lens 3 can be decreased by omitting sensors at positions corresponding to the thumb of the left hand. Furthermore, the lens CPU 7 may control the light emitting sections 10a to 10d of the pulse detection apparatus 12 to emit light only when in contact with a finger.

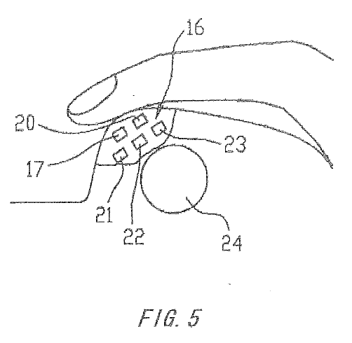

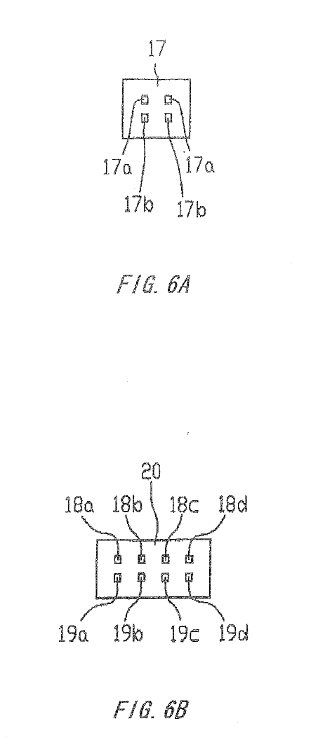

Returning to FIG. 2, the camera body 2 of the present embodiment includes a camera-side biosensor section 16 that detects the pressure with which the camera body 2 is held, body temperature, amount of sweat, blood pressure, blood flow, or heart rate of the photographer, for example, at a position where a finger or the palm of the right hand of the photographer touches the camera-side biosensor section 16. As shown in FIG. 5, the camera-side biosensor section 16 includes a plurality of electrode sections 17 that have a similar configuration to the electrode sections 9 and a pulse detection apparatus 20 that has a similar configuration to the pulse detection apparatus 12. In other words, as shown in FIG. 6(a), the electrode sections 17 include a reference electrode 17a and a detection electrode 17b distanced from each other. As shown in FIG. 6(b) the pulse detection apparatus 20 includes a plurality of light emitting sections 18a to 18d and a plurality of light receiving sections 19a to 19d, and detects the pulse. The camera-side biosensor section 16 includes a sweat sensor 21 that detects the amount of sweat of the photographer, a temperature sensor 22 that detects the body temperature of the photographer, and a pressure sensor 23 that detects the pressure used by the photographer to hold the camera body 2.

As made clear from FIG. 2, when the photographer holds the camera body 2, the thumb of the right hand is positioned on the hack surface of the camera body 2 and the pointer finger of the right hand is positioned near the release SW 24, and are therefore distanced from the other three fingers. Therefore, the camera-side biosensor sections 16 are distanced from each other and positioned at the back surface position of the camera 2 corresponding to the thumb of the right hand, the region near the release SW 24, and the front surface position of the camera where the other three fingers are used to hold the camera body 2. A camera-side biosensor section 16 may be disposed on the release SW 24. Here, the camera-side biosensor sections disposed at the camera back surface position and the camera front surface position are not shown in the drawings, but have the same configuration as the camera-side biosensor section 16. In the camera body 2, at least one of the camera front position where the other three fingers hold the camera body 2 and the camera back position corresponding to the thumb of the right hand can serve as a holding section for holding the camera body 2. A plurality of operation SWs are disposed on the back surface of the camera body 2, and these operation SWs are operated by the thumb of the right hand. Therefore, in the present embodiment, at least one of the SWs operated by the thumb of the right hand, the release SW 24, and the power supply switch is an operating section for operating the camera body 2. An image capturing mode SW 25 is disposed on the top surface of the camera body 2 to set the image capturing mode.

Returning to FIG. 1, the camera body 2 includes a movable mirror 28 and a sub mirror 30. The sub mirror 30 can rotate between a reflecting position, which is a position for reflecting light from the photography lens 3 to a tinder optical system 26, described further below, and a withdrawn position in which the movable mirror 28 is withdrawn such that the light from the photography lens 3 is incident to a image capturing element 27, which is formed by CCD or CMOS elements. The sub mirror 30 reflects light that passes through a semi-transparent region, which is a portion of the movable mirror 28, to a focal point detection sensor 29 that detects the focal point based on phase difference.

The light reflected by the movable mirror 28 is guided to the finder optical system 26 through a reticle 31 and a pentaprism 32. The finder optical system 26 is formed by a plurality of lenses, and the photographer can use the finder optical system 26 to check the field being captured. On the other hand, when the movable mirror 28 is at the withdrawn position, the light from the photography lens 3 is incident to the image capturing element 27 through the low-pass filter 33. An image capturing substrate 34 is disposed near the image capturing element 27.

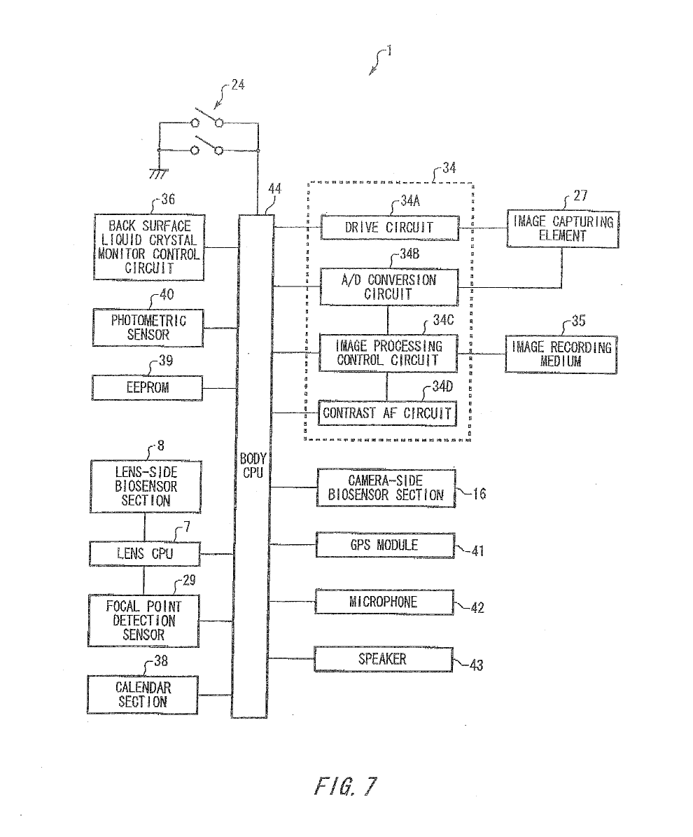

FIG. 7 is a block diagram of the camera system 1, and is referenced along with FIG. 1 in the following description. The image capturing substrate 34 includes a drive circuit 34A that drives the image capturing element 27, an A/D conversion circuit 34B that converts the output of the image capturing element 27 into a digital signal, and an image processing control circuit 34C that is formed by an ASIC, for example. The image processing control circuit 34C applies image processing such as white balance adjustment, sharpness adjustment, gamma adjustment, and grayscale adjustment to the image signal resulting from the conversion of the digital signal, and also performs image compression to a JPEG format, for example. The compressed image is stored in the image recording medium 35 and, under the control of the back surface liquid crystal monitor control circuit 36, is displayed in the back surface liquid crystal monitor 37 as a live view image. Furthermore, when the movable mirror 28 is at the withdrawn position, the back surface liquid crystal monitor control circuit 36 can display information within the finder field and display the image (live view image) in the display section, not shown.

The image capturing substrate 34 includes a contrast AF circuit 34D that extracts the high frequency component of the signal from the image capturing element 27 and detects the focus lens position at which the high frequency component is at a maximum. The contrast AF circuit 34D receives the image signal from the image processing control circuit 34C. The contrast AF circuit 34D extracts a prescribed high frequency component from the captured image signal using a band-pass filter, generates an AF evaluation signal by performing wave detection such as a peak hold or integration operation, and outputs the AF evaluation signal to the CPU 44.

Sound gathered by a microphone 42 described further below can be added to the live view image described above, in order to generate a moving image by performing an MPEG or H.264 process, for example. The frame rate of the moving image can beset to 30 fps, for example.

As described above, the lens CPU 7 corrects for camera shake by driving the image-stabilizing lens in the photography lens 3 in a direction other than the optical axis direction using a drive apparatus, not shown, in a manner to cancel out the camera shake detected by the angular velocity sensor 6. In addition to the optical camera shake correction, the camera shake correction may also cancel out the camera shake by driving the image capturing clement 27 in a direction other than the optical axis direction, or may cancel out the camera shake by performing an electronic vibration correction. The electronic vibration correction includes calculating the movement (movement amount) between a plurality of images output from the image processing control circuit 34, reading the images, and controlling the position of the images to cancel out the calculated movement (movement amount) between the images to correct the image vibration in the image recording medium 35. The implementation of these camera shake correcting methods is described further below.

The calendar section 38 includes a clocking integrated circuit and a crystal oscillator, and automatically clocks calendar information including the year, month, day, hour, and minute. An EEPROM (electrically erasable programmable read only memory) 39 serves as a storage apparatus that stores setting values and adjustment values of the camera, and also stores date and time data of the time of manufacture in addition to AF adjustment data, AE adjustment data, and the like. The EEPROM 39 also stores biometric information values of a person. In the present embodiment, the EEPROM 39 stores, as the biometric information, the pressure with which the photography lens 3 is held, the pressure with which the camera body 2 is held, body temperature, amount of sweat, blood pressure, blood flow, and heart rate. The biometric information of the photographer is measured in advance in a normal state and stored. Furthermore, the biometric information values may be stored as data specified by the photographer.

The camera body 2 includes a photometric sensor 40 that measures brightness of the field being captured near the pentaprism 32, and a GPS (Global Positioning System) module 41 disposed above the pentaprism 32. The camera body 2 receives a signal from a GPS satellite to acquire measurement information (latitude, longitude, altitude). The camera body 2 includes a microphone 42 that records sound in the field being captured positioned in a manner to not interfere with the photography lens 3 when the photography lens 3 is mounted on a mount section, and also includes a speaker 43 near the finder optical system 26. The release SW 24 is a two-stage switch, and when the photographer presses the release SW 24 half way, detection of the biometric information of the photographer by the lens-side biosensor section 8 and the camera-side biosensor section 16 begins and photographing preparation processes, e.g. autofocus and light measurement, are performed. When the photographer fully presses the release SW 24, photographing instructions (still image or moving image) arc issued.

The body CPU 44 works together with the lens CPU 7 to control the overall camera system 1. In the present embodiment, this control includes acquiring the biometric information of the photographer based on the output of the camera-side biosensor section 16 and the lens-side biosensor section 8 and assisting in the operation and setting of the camera system 1. The following describes the acquisition of the biometric information of the photographer by the lens-side biosensor section 8 and the camera-side biosensor section 16.

(Heart Rate Measurement)

As described above, the reference electrodes 9a and detection electrodes 9b of the electrode sections 9 are disposed at positions where the photography lens 3 is held by the left hand of the photographer, and the reference electrodes 17a and detection electrodes 17b of the electrode sections 17 are disposed at positions where the camera body 2 is held by the right hand of the photographer. The difference between the potentials detected by the detection electrodes 9b and 17b is amplified by a differential amplifier, not shown, and output to the body CPU 44. The body CPU calculates the heart rate of the photographer based on the potential difference between the detection electrodes 9b and 17b.

If the photographer is not holding the photography lens 3, the left hand of the photographer is not in contact with the reference electrode 9a or the detection electrode 9b, and therefore the connection between the reference electrode 9a and the detection electrode 9h is open. When the connection between the reference electrode 9a and the detection electrode 9b is open, the lens CPU 7 determines that the photographer is not holding the photography lens 3. Similarly, when the connection between the reference electrode 17a and the detection electrode 17b of the heart rate detection apparatus is open, the body CPU 44 determines that the photographer is not holding the camera body 2.

(Blood Pressure Measurement)

The pulse detection apparatuses 12 and 20 measure the blood pressure of the photographer. The pulse detection apparatus 12 and the pulse detection apparatus 20 have the same configuration, and therefore the following detailed description of the pulse measurement includes only the pulse detection apparatus 12. The pulse detection apparatus 12 emits infrared rays, for example, from the light emitting sections 10a to 10d, the infrared rays are reflected by the arteries in the finger, and the reflected infrared rays are received by the light receiving sections 11a to 11d, which are infrared sensors, to detect the pulse in the finger, i.e., to detect the amount of blood flow in peripheral vessels. The body CPU 44 calculates the blood pressure of the photographer based on the pulse received from the pulse detection apparatus 12. When it is determined that a finger of the photographer, e.g. the pinky, is not touching the photography lens 3 based on the outputs of the reference electrodes 9a and the detection electrodes 9b of the electrode sections 9, the lens CPU 7 prevents meaningless light output and the emission of stray light into the capture field by prohibiting the emission of light from the light emitting section arranged to correspond to the pinky finger. Similarly, when it is determined that the thumb of the photographer is not touching the camera 2 based on the outputs of the reference electrodes 17a and the detection electrodes 17b of the electrode section 17, the body CPU 44 may prohibit light emission from the light emitting section 18 of the pulse detection apparatus 20.

(Sweat Measurement)

Sweat can be detected by measuring the impedance of the hand. The sweat sensors 13 and 21 have a plurality of electrodes and detect sweat. A portion of these electrodes may also be used as the reference electrodes 9a and the reference electrodes 17a. A sweat sensor 13 is disposed in each of the lens-side biosensor sections 8A to 8D, but since sweat caused by emotional states such as happiness, excitement, or nervousness occurs in small amounts and in a short time, the lens-side biosensor sections 8B and 8C may he disposed at positions corresponding to the center of the palm, which creates more sweat than the fingers.

(Temperature Measurement).

The temperature sensors 14 and 22 use thermistors with resistance values that change due to heat. There are different types of sweat including emotional sweat described above and thermal sweat for regulating body temperature, and these types of sweat can interfere with each other. Therefore, the body CPU 44 can determine whether the sweat of the photographer is emotional sweat or thermal sweat based on the outputs of the sweat sensors 13 and 21 and the outputs of the temperature sensors 14 and 22. For example, the body CPU 44 can determine the thermal sweat to be the sweat occurring when the temperature detected by the temperature sensor 22 is high and the sweat signal from the sweat sensor 21 is detected normally. Furthermore, the body CPU 44 can determine the emotional sweat to be sweat occurring when the sweat signal from the sweat sensor 21 is irregular, and therefore detect that the photographer is happy, excited, or nervous. If the temperature sensors 14 and 22 are not included, the body CPU 44 may judge whether the sweat signals from the sweat sensors 13 and 21 indicate emotional sweat or thermal sweat based on position information from the GPS module 41 or date and time information from the calendar section 38, for example. Furthermore, the lens CPU 7 may determine the sweat of the left hand to be emotional sweat or thermal sweat based on the output of the sweat sensor 13 and the output of the temperature sensor 14.

(Pressure Measurement)

The pressure sensor 15 is an electrostatic capacitance sensor, and measures a deformation amount caused by a pressing force when the photographer holds the photography lens 3. In the present embodiment, the pressure sensor 15 is disposed below operating rubber. The pressure sensor 23 is a similar electrostatic capacitance sensor, and measures the deformation amount caused by a pressing force when the photographer holds the camera body 2. The pressure sensors 15 and 23 may use distortion gauges or electrostriction elements, for example.

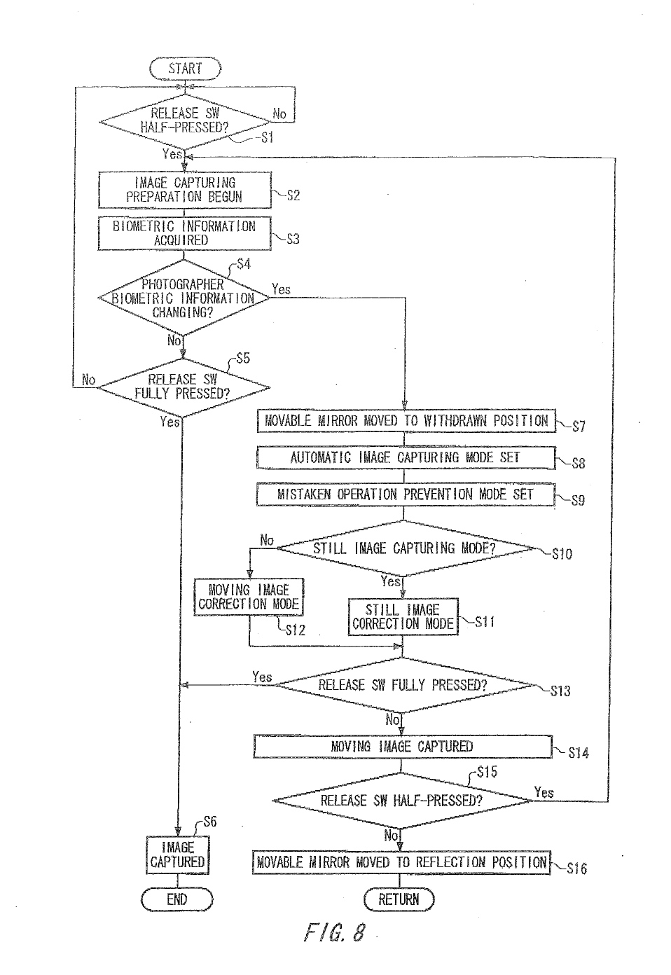

FIG. 8 is a flow chart showing a process for detecting the biometric information of the photographer and setting the image capturing conditions, performed under the control of the body CPU 44. The following describes a state of the camera body 2 in which the main switch (power supply switch) is turned ON.

The body CPU 44 determines whether the release SW 24 is pressed half way, proceeds to step S2 if the release SW 24 is pressed half way, and repeats the determination of step S1 if the release SW 24 is not pressed half way (step S1). The body CPU 44 begins image capturing preparation when the release SW 24 is pressed half way (step S2). More specifically, the body CPU 44 detects the focal position in the capture field using the focal point detection sensor 29 and measures the brightness of the capture field using the photometric sensor 40.

When the live view mode is set by the setting SW, not shown, disposed on the back surface of the camera body 2, the body CPU 44 withdraws the movable mirror 28 to the withdrawn position and, under the control of the back surface liquid crystal monitor control circuit 36, displays the image (live view image) in the back surface liquid crystal monitor 37. When the live view mode is not set by the setting SW, not shown, the body CPU 44 sets the movable minor 28 at the reflection position. The body CPU 44 operates together with the lens CPU 7 to detect the biometric information of the left hand of the photographer using the lens-side biosensor sections 8 and to detect the biometric information of the right hand of the photographer using the camera-side biosensor sections 16 (step S3). The body CPU 44 detects the pressures (holding forces) with which the camera body 2 and the photography lens 3 are held, the heart rate, the blood flow, the blood pressure, the sweat, and the body temperature of the photographer. The order in which steps 82 and S3 are performed may be switched, or these steps may be performed at the same time.

The body CPU 44 compares the biometric information values stored in the EEPROM 39 to the biometric information of the photographer acquired in step 53, to determine whether the biometric information has changed, in other words, whether the photographer is in an excited state or a tired state (step S4). When the detected heart rate and blood pressure are 10% or more greater than the heart rate and blood pressure stored in the EEPROM 39, the body CPU 44 determines that the photographer could be excited, and references the state of the sweat and the pressures (holding forces) with which the camera body 2 and the photography lens 3 are held.

When the sweat signal output from the sweat sensors 13 and 21 is irregular, the body CPU 44 determines that the sweat is emotional sweat and therefore determines that the photographer is in an excited state. If the sweat cannot be determined to be emotional sweat or thermal sweat, the body CPU 44 references the pressure (holding force) with which the camera body 2 and photography lens 3 are held, and determines the photographer to he in the excited state if one of the pressures (holding forces) is 10% or more greater than the pressure stored in the EEPROM 39.

Instead of or in addition to the outputs of the sweat sensors 13 and 21 and the outputs of the pressure sensors 15 and 23, the body CPU 44 may reference the output of the microphone 42. When the output of the microphone 42 increases by 10 decibels or more, e.g. when the output increases from 60 decibels to 70 decibels, the body CPU 44 may determine that something is happening nearby that will soon cause a good image capturing chance or that the photographer will soon be excited.

Furthermore, using the output of the GPS module 41, the body CPU 44 may determine when the image capturing location is a school, sports field, or wedding space, for example, and change the threshold value for determining excitement. More specifically, since the output of the microphone 42 fluctuates more due to loud voices when capturing images at a school or sporting event, for example, the judgment that the photographer is expected to be excited is made when the output of the microphone 42 increases by 20 decibels or more. Since many pictures are often taken after a speech by an emcee when at a wedding space, the body CPU 44 may determine that many image capturing opportunities are coming soon or that the photographer is expected to be excited after the output of the microphone 42 has decreased.

The body CPU 44 determines that the photographer is excited when the heart rate and blood pressure are 15% or more greater than the heart rate and blood pressure stored in the EEPROM 39. In this case, the outputs of the sweat sensors 13 and 21 and the outputs of the pressure sensors 15 and 23 need not be referenced. Instead of comparing the biometric information values stored in the EEPROM 39 to the biometric information of the photographer acquired at step S3 as described above, the body CPU 44 may determine whether the photographer is excited based on a rate of change of the biometric information of the photographer acquired at step S3. More specifically, the body CPU 44 may determine whether the photographer is excited based on whether the heart rate and blood pressure of the photographer are increasing over time. If the heart rate and blood pressure of the photographer are increasing over time but the rate of increase is less than 10%, the body CPU 44 references the outputs of the sweat sensors 13 and 21 and the outputs of the pressure sensors 15 and 23 as described above to determine whether the photographer is excited. As described above, the body CPU 44 may determine whether the photographer is excited based on the output of the microphone 42 or the output of the GPS module 41.

The body CPU 44 calculates the blood flow based on the pulse detected by the pulse detection apparatuses 12 and 20, and calculates the tiredness of the photographer based on these calculation results. In other words, since there is a correlation between blood flow and tiredness, the body CPU 44 compares the blood flow of the photographer at a normal time stored in the EEPROM 39 and the calculated blood flow, and determines the photographer to he tired when the blood flow increases by a prescribed threshold value or more.

When it is determined at step S4 that the biometric information of the photographer is not changing, the body CPU 44 determines whether the release SW 24 is fully pressed at step S5, and performs image capturing at step S6 when the release SW 24 is fully pressed. This image capturing includes capturing a moving image or a still image, according to the setting of the setting SW, not shown, or the image capturing mode SW 25. The setting for still image capturing or moving image capturing may be selected using the image capturing mode SW 25, or a switch dedicated to moving image capturing may be included and moving image capturing may be started by pressing the moving image capturing switch while the live view mode is sect by the setting SW, not shown.

The body CPU 44 returns to step S1 if the release SW 24 is not fully pressed at step S5. On the other hand, if it is determined at step S4 that the photographer is excited or tired, even if the live view mode is not set by the setting SW, not shown, on the back surface of the camera body 2, the body CPU 44 moves the movable mirror 28 to the withdrawn position and uses the back surface liquid crystal monitor control circuit 36 to display the image (live view image) in the back surface liquid crystal monitor 37 (step S7). This is in order to achieve reliable image capturing, as described below, when the photographer is excited or tired, i.e. in a state differing from the normal state. Since the movable mirror 28 is at the withdrawn position, the body CPU 44 applies contrast AF using the output of the image capturing clement 27 instead of the focal point detection sensor 29.

Next, the body CPU 44 sets the camera system 1 to an automatic image capturing mode (step 88). Specifically, the body CPU 44 sets automatic exposure (AE) and autofocus (AF), and also automatically sets the image capturing scene to be for a portrait, sports, scenery, evening scenery, or night scenery, for example. This automatic setting is performed based on light measurement results of the photometric sensor 40, time information from the calendar section 38, and position information from the GPS module 41. The body CPU 44 may set the ISO to achieve higher sensitivity than usual (e.g., greater than or equal to an ISO of 800), and display a level marker in the finder for preventing inclination of the camera system 1.

When the excitement of the photographer is greater than or equal to a medium amount, e.g. when the outputs of lens-side biosensor sections 8 and camera-side biosensor sections 16 are increased by 15% or more, the body CPU 44 may set the automatic image capturing mode. The automatic image capturing mode may be set to be active or inactive, or individual functions of the automatic image capturing mode can each be set to be active or inactive.

Next, the body CPU 44 sets a mistaken operation prevention mode (step S9). In the mistaken error prevention mode, when prescribed operations such as operating the power supply switch, operating the release SW 24, deleting images, or formatting the image storage medium 35, for example, are performed by the photographer, a confirmation display or warning display is shown using characters or icons in the finder, in the back surface liquid crystal monitor 37, or in both the finder and the back surface liquid crystal monitor 37. The body CPU 44 may output a confirmation or warning sound from the speaker 43. The body CPU 44 may prohibit the prescribed operations. Specifically, the body CPU 44 may prohibit the power supply switch from being turned OFF, deletion of captured images by an image deleting section, editing of captured images by an image editing section, and formatting of the image storage medium 35, for example. Even when the power supply switch is prohibited from being turned OFF, the body CPU 44 may turn OFF the power supply switch if the operation for turning OFF the power supply switch is performed a plurality of times. Even when deletion of captured images by the image deleting section and editing of captured images by the image editing section are prohibited, the body CPU 44 may delete captured images using the image deleting section if instructions for deleting the captured images using the image deleting section are received a plurality of time via the operating section, and may edit captured images using the image editing section if instructions for editing the captured images using the image editing section are received a plurality of time via the operating section. The mistaken operation prevention mode may be set to be active or inactive, or each individual function of the mistaken operation prevention mode may be set to be active or inactive.

Next, the body CPU 44 determines whether the set image capturing mode is the still image capturing mode (step S10). When the still image capturing mode is set, the body CPU 44 enters the still image correction mode (step S11). When the still image capturing mode is not set, the moving image capturing mode is set, and therefore the body CPU 44 enters the moving image correction mode (step S12).

In the still image correction mode at step S11, the amount of camera shake increases when the photographer is excited, and therefore the exposure control is changed to shorten the exposure time, in order to decrease the effect of camera shake. In this case, the exposure calculation program flow of the camera system 1 is changed such that the shutter time becomes shorter. In this way, the time during which the shutter, not shown, is open becomes shorter, and the image capturing lime of the image capturing element 27 also becomes shorter. When the photographer is excited, the amplitude of the camera shake tends to be larger and the dominant blur vibration frequency tends to he shifted to be higher than when the photographer is in an emotional state in which the blur vibration characteristics due to camera shake arc low. Therefore, the camera shake correction is also changed to use control parameters for applying camera shake correction corresponding to a larger amplitude and a faster period than the camera shake correction normally used. For example, in a camera shake correction system using an angular velocity sensor 6 including a normal gyro sensor, when capturing an image with the image capturing element 27, signal processing for detecting mostly low frequency vibration around several Hertz (e.g. 2 Hertz) is applied, and the cutoff frequency of a digital filter in a digital circuit, not shown, is changed in a manner to primarily detect a frequency (e.g. 6 to 10 Hertz) that is a multiple of the previous frequency. Since the amplitude is larger when the change in the biometric information is greater, the camera shake cannot be completely corrected using one type of camera shake correction. Therefore, in the present embodiment, the three camera shake correction methods described above are combined to correct the camera shake when the amplitude is large. More specifically, the lens CPU 7 drives the image-stabilizing lens based on the amount of camera shake detected by the angular velocity sensor 6, and the body CPU 44 calculates the amount of camera shake that cannot be corrected by the drive amount of the image-stabilizing lens based on the camera shake amount detected by the angular velocity sensor 6 and drives the image capturing element 27 based on this calculated camera shake amount. Instead of driving the image capturing element 27, the body CPU 44 may perform an electronic vibration correction or use all three of the camera shake correcting methods. A selection from among the three camera shake correction methods described above can be made based on the remaining battery life of the camera system 1. For example, the body CPU 44 may receive data concerning the weight of the image-stabilizing lens from the lens CPU 7, compare this weight to the weight of the image capturing element 27, drive whichever component has less weight, and combine this process with an electronic camera shake correction.

When in the moving image correction mode of step S12, in the same manner as when in the still image correction mode, the body CPU 44 shortens the exposure time of each frame in order to decrease the effect of camera shake. In this case, the body CPU 44 performs camera shake correction or changes the exposure calculation program flow of the camera system 1 to shorten the shutter time. Since the exposure time here is longer than the exposure time used for a still image, a wider correction tracking range for the camera shake correction is required. In other words, the correction for the blur vibration is set to be less precise than in the case of a still image, and the camera shake correction patterns are changed such that the correction focuses on vibration with a high amplitude. For example, when tracking an amplitude of N degrees/second in normal moving image capturing, where N is a positive real number, at least one of the image-stabilizing, lens and the image capturing element 27 is driven to track an amplitude of 2N to 5N when the photographer is excited. Furthermore, the amplitude to be tracked may he selected from a range of 2N to 5N according to how excited the photographer is, i.e. according to the amount of change of the biometric information. The camera shake amplitude may be corrected when the amplitude exceeds a prescribed value, based on the amount of change of the biometric information.

The body CPU 44 references the composition stability (appearance) between frames of the moving image, and changes the normal frame rate of the moving image capturing to be a higher frame rate, e.g. to a rate of 60 fps when the normally set frame rate is 30 fps.

Furthermore, when recording the moving image, sound is usually recorded at the same time as the image. When the photographer is excited, there is a chance that the photographer will use a loud voice during the image capturing, and therefore the body CPU 44 sets the sound recording gain to be some percentage lower than the normal sound recording gain, in order to restrict the saturation of the sound recording level (sound distortion caused by the input of a loud sound). The still image correction mode and the moving image correction mode may each he set to he active or inactive.

The body CPU 44 determines at step S13 if the release SW 24 is fully pressed, and moves to step S6 to perform image capturing if the release SW 24 is fully pressed. In this case, when one of the automatic image capturing mode, the mistaken operation prevention mode, the still image correction mode, and the moving image correction mode is set to be active, the image capturing is performed using the function of the set mode. In this case, the photographer is detected as being excited and the movable mirror 28 is moved in advance to the withdrawn position, and therefore the image capturing can be performed immediately.

On the other hand, if the release SW 24 is not fully pressed at step S13, the body CPU 44 captures a moving image (step S14). The moving image capturing at step S14 is to ensure image capturing even when the photographer is excited. Specifically, whichever of the still image capturing mode and the moving image capturing mode is set, the body CPU 44 captures a short moving image of approximately 4 to 6 seconds, for example. At this time, the body CPU 44 displays notification that a moving image is being captured on at least one of the finder optical system 26 and the back surface liquid crystal monitor 37. As a result, the photographer can confirm that a backup moving image is being recorded, thereby eliminating the worry of missing a good picture opportunity. In this case, the display of the backup moving image recording is preferably different from the display of the normal moving image recording. Specifically, the display of the backup moving image recording may be made more noticeable by showing a flashing light, changing the color, or changing the size of the display, for example.

By extracting a still image from the captured moving image, a still image can be obtained even if the photographer missed the picture opportunity. Furthermore, the body CPU 44 sets the frame rate or sets the moving image capturing time to be from 4 to 6 seconds, according to the remaining capacity in the image recording medium 35. When there is little remaining capacity in the image recording medium 35, the body CPU 44 can set the moving image capturing time to 3 seconds or less, or can switch to still image capturing. In this case, the body CPU 44 may determine the number of still image captures or determine the number of images to be captured in series, according to the remaining capacity of the image recording medium 35. When capturing a moving image, the sound may he recorded or not, and sound need not be recorded when the frame rate exceeds 60 fps, for example.

At step S14, the body CPU 44 determines whether the release SW 24 is half-pressed after the short moving image capturing is finished (step S15), and returns to step 82 if the release SW 24 is half-pressed. When proceeding again from step S2 to step S14, the moving image can be captured intermittently. On the other hand, when the release SW 24 is not half-pressed at step S15, the body CPU 44 returns the movable mirror 28 to the reflection position (step 816). Furthermore, tag information is generated indicating that an image was captured when the photographer was excited or tired, and if this tag information is stored in a separate holder such as a holder for images captured when excited, images that arc of interest to the photographer can be easily extracted during editing.

In the flow chart of FIG. 8, the image capturing preparation is begun when the release SW 24 is half-pressed at step S1, but instead, when the hands of the photographer respectively touch the lens-side biosensor sections 8 and the camera-side biosensor sections 16, the outputs of the lens-side biosensor sections 8 and the camera-side biosensor sections 16 may be detected, and the image capturing preparation may be begun when the photographer is detected to be excited, in the same manner as when the release SW 24 is half-pressed. As a result, focused images can be recorded even when the photographer suddenly fully presses the release SW 24.

In the present embodiment, the biometric information of the photographer is acquired based on the outputs of the lens-side biosensor sections 8 and the camera-side biosensor sections 16, but the emotional change of the photographer can be estimated as if change of the biometric information is detected. In this case, there is no need to use especially expensive sensors for the lens-side biosensor sections 8 and the camera-side biosensor sections 16.

Furthermore, if the outputs of the lens-side biosensor sections 8 and the camera-side biosensor sections 16 are stored in a storage apparatus, not shown, in association with data and time information of the calendar section 38 or location information from the UPS module 41, change in the biometric information of the photographer corresponding to date, time, and image capturing location can be recorded. In this case, change in biometric information for each photographer is preferably stored in the storage apparatus, not shown.

(Correction Mode)

The body CPU 44 may correct a threshold value for determining the emotional state of the photographer based on the values obtained by the lens-side biosensor sections 8 and the camera-side biosensor sections 16, using time and date information from the calendar section 38 or the GPS module 41 disposed in the camera body 2. Specifically, if the output of the GPS module 41 indicates that the photographer is in Hokkaido and the season is winter, the blood pressure of the photographer is high, and therefore the threshold value for determining excitement of the photographer may be increased.

In the embodiment described above, the automatic image capturing mode and the mistaken operation prevention mode arc set at the same time, but instead, just one of the automatic image capturing mode and the mistaken operation prevention mode may be set.

In the embodiment described above, when detecting how tired the photographer is based on the biometric information, the time from when the power supply of the camera 2 is turned ON, the number of times the release SW 24 is operated, or the total moving image capturing time may be referenced. In this case, the level of tiredness of the photographer can be more accurately detected. For example, the photographer can be determined to be tired when the total time during which the power supply is ON in one day exceeds one hour, when the release SW 24 has been operated more than 200 times, or when the total moving image capturing time is more than one hour, for example.

The camera system 1 of the present embodiment can capture images without error when a photographer is not in the usual state, e.g., when the photographer is excited or tired. For example, a parent might capture images of their child at a sporting even while being excited and cheering, and in this case the camera system 1 can capture images without error while performing a suitable camera shake correction.

The camera system 1 of the present embodiment described above is exemplified by a single-lens reflex camera system with a replaceable lens including a movable mirror 28, but an image capturing assistance function using the outputs of the lens-side biosensor sections 8 and the camera-side biosensor sections 16 can also be adopted in a mirrorless camera, which does not include the movable mirror 28, the pentaprism 32, or the like, with a replaceable lens. In this case, the movable mirror 28 is not included, and therefore the steps S7 and S16 can be omitted from the flow chart shown in FIG. 8. Furthermore, since the movable mirror 28 is not included, the light from the capture field does not reach the focal point detection sensor 29. Therefore, focal point detection may be performed by the image capturing element 27 using contrast AF, instead of by the focal point detection sensor 29. Japanese Patent Application Publication No. 2007-233032 (US Patent Application Publication 20070206937) proposes image capturing element AF that includes performing phase-difference AF by providing AF detection pixels in the image capturing clement. Accordingly, by adopting this image capturing element AF in a mirrorless camera with a replaceable lens, the contrast AF and phase-difference AF can be used together.

Furthermore, the control method using the output of the camera-side biosensor sections 16 according to the present invention can be adopted in a video camera.

In the embodiment described above, the biometric information is detected from both hands of the photographer using the lens-side biosensor sections 8 and the camera-side biosensor sections 16, but detection results obtained for one hand by the sweat sensors 13 or 21, the temperature sensors 14 or 22, and the pressure sensors 15 and 23 may be used instead. If there is a detection method by which other sensors can obtain detection results from one hand, then this detection method may be used as well.

A wearable biosensor may be used instead of the lens-side biosensor sections 8 and the camera-side biosensor sections 16. As another example, a wearable biosensor may be used that works together with the lens-side biosensor sections 8 and the camera-side biosensor sections 17. The wearable biosensor may be formed as a bracelet or ring, for example. In this case, the output of the wearable biosensor should be transmitted to the camera body 2 by a short-range communication signal. A biosensor formed as a bracelet is disclosed in detail in Japanese Patent Application Publication No. 2005-270543 (U.S. Pat. No. 7,538,890), for example.

In the embodiment described above, the determination concerning whether the photographer is excited is based on the biometric informulation, but instead, the level of excitement of the photographer may be determined based on the biometric information of the photographer, different control may be performed in the still image correction mode and the moving image correction mode according to this excitement level. Furthermore, the camera shake correction described above may be performed when it is determined that the photographer is irritated based on the biometric information.

In the above embodiment, there is no specific description about the power supply, but it is obvious that the camera system 1 operates by receiving power. The camera system 1 can continuously receive power from a domestic AC power supply, and can also receive power from a detachable battery. The battery may be one-dimensional or two-dimensional.

A plurality of batteries can be attached and detached according to the properties of the device that supplies power. For example, when the camera body 2 and the photography lens 3 are formed as separate units, as in the above embodiment, a battery may be equipped in each unit. In this case, the battery equipped in the camera body 2 may provides power primarily to the camera body 2, and the battery equipped in photography lens 3 provides power primarily to the photography lens 3. Accordingly, the drive power for driving the focus lens is supplied by the battery equipped in the photography lens 3. Of course, when a battery is empty, for example, one of the batteries can supply power to compensate for the empty battery.

### DESCRIPTION OF THE REFERENCE NUMERALS

1 camera system, 2 camera body, 3 photography lens, 8 (8A to 8D) lens-side biosensor section, 16 camera-side biosensor section, 26 finder optical system, 27 image capturing clement, 28 movable mirror, 38 calendar section, 41 GPS module, 42 microphone

1. A photography lens comprising a first biometric detection apparatus that is capable of detecting change in biometric information of a photographer.

2. The photography lens according to claim 1, comprising an operating member that enables operation of at least one lens, wherein
the first biometric detection apparatus is disposed in the operating member or near the operating member.

3. The photography lens according to claim 1, wherein
the first biometric detection apparatus includes a plurality of electrode sections distanced from each other.

4. The photography lens according to claim 1, wherein
the first biometric detection apparatus includes a light emitting section that emits light toward a palm of the photographer and a light receiving section that is disposed adjacent to the light emitting section and receives light reflected by the palm.

5. The photography lens according to claim 1, wherein the first biometric detection apparatus includes:
a sweat sensor that detects sweat on a palm; and
a determining section that determines whether the sweat detected by the sweat sensor is caused by an emotional state.

6. A photographing apparatus that captures an image, comprising:
a holding section that holds the photographing apparatus;
an operating section to perform an image capturing operation; and
a second biometric detection apparatus that is capable of detecting change in biometric information of a photographer and that is disposed in at least one of the holding section and the operating section.

7. The photographing apparatus according to claim 6, wherein
the second biometric detection apparatus includes a plurality of electrode sections distanced from each other.

8. The photographing apparatus according to claim 6, wherein
the second biometric detection apparatus includes a light emitting section that emits light toward a palm of the photographer and a light receiving section that is disposed adjacent to the light emitting section and receives light reflected by the palm.

9. The photographing apparatus according to claim 6, wherein the second biometric detection apparatus includes;
a sweat sensor that detects sweat on a palm; and
a determining section that determines whether the sweat detected by the sweat sensor is caused by an emotional state.

10. A photographing system comprising:
a first biometric detection apparatus that is disposed in a photography lens and is capable of detecting change in biometric information of a photographer;
a second biometric detection apparatus that is disposed in a photographing apparatus body and capable of detecting change in the biometric information of the photographer; and
a detection apparatus that is disposed in the photographing apparatus body and detects change in the biometric information of the photographer based on the detection results of the first and second biometric detection apparatuses.

11. The photographing system according to claim 10, wherein
the first biometric detection apparatus includes a plurality of first electrode sections distanced From each other,
the second biometric detection apparatus includes a plurality of second electrode sections distanced from each other, and
the detection apparatus detects change in heart rate of the photographer based on outputs of the first and second electrode section.

12. The photographing system according to claim 10, wherein
the first biometric detection apparatus includes a first light emitting section that emits light toward a palm of the photographer and a first light receiving section that is disposed adjacent to the first light emitting section and receives light reflected by the palm.
the second biometric detection apparatus includes a second light emitting section that emits light toward the palm of the photographer and a second light receiving section that is disposed adjacent to the second light emitting section and receives light reflected by the palm, and
the detection apparatus detects change in blood pressure of the photographer based on outputs of the first and second light receiving sections.

13. The photographing system according to claim 10, wherein
the first biometric detection apparatus includes a First sweat sensor that detects sweat on a palm,
the second biometric detection apparatus includes a second sweat sensor that detects sweat on the palm, and
the detection apparatus determines whether the sweat detected by the first and second sweat sensors is caused by an emotional state.

14. The photographing system according to claim 10, comprising at least one of a position detector that detects position information and a date and time information detection apparatus that detects date and time information, wherein
the detection apparatus corrects the detection results of the first and second biometric information apparatuses based on output of the at least one of the position detector and the date and time information detection apparatus.

15. The photographing system according to claim 10, comprising a control section that begins image capturing preparation when the first and second biometric detection apparatuses detect change in the biometric information of the photographer.

16. The photographing system according to claim 10, comprising a plurality of the first biometric detection apparatuses provided according to orientation of the photographing apparatus body.

17. A photographing apparatus comprising:
a photographing section that captures an image using a photography lens;
a setting section that performs setting relating to the image capturing; and
a control section that changes at least a portion of a state of the photographing section and the setting of the setting section when the photographing section performs image capturing based on biometric information of a photographer.

18. The photographing apparatus according to claim 17, wherein
the setting section is capable of setting still image capturing and moving image capturing, and
even when the still image capturing is set by the setting section, the control section is capable of performing the moving image capturing when performing image capturing based on the biometric information of the photographer.

19. The photographing apparatus according to claim 17, comprising an optical member that is capable of moving to a first position at which the optical member guides light to the photographing section and a second position at which the optical member does not guide light to the photographing section, wherein
the control section moves the optical member to the first position to change the state of the photographing section, based on the biometric information of the photographer.

20. The photographing apparatus according to claim 17, comprising:
a first focal point detection apparatus that detects a focal point of the photography lens; and
a second focal point detection apparatus that is different from the first focal point detection apparatus, wherein
the control section changes the state of the photographing section by switching from the first focal point detection apparatus to the second focal point detection apparatus when performing image capturing based on the biometric information of the photographer.

21. The photographing apparatus according to claim 17, wherein
the control section performs one of moving image capturing and still image capturing, according to capacity of a storage medium that stores captured images,

22. The photographing apparatus according to claim 17, wherein
the control section performs intermittent image capturing when performing moving image capturing based on the biometric information of the photographer.

23. The photographing apparatus according to claim 17, wherein
the control section captures a plurality of still images when performing still image capturing based on the biometric information of the photographer.

24. The photographing apparatus according to claim 17, comprising a sound gathering apparatus that gathers sound, wherein
the control section captures images using the photographing section based on the biometric information of the photographer and on the sound gathered by the sound gathering apparatus.

25. The photographing apparatus according to claim 17 comprising a visual confirmation apparatus that allows the photographer to view a field being captured, wherein
the control section displays notification in the visual confirmation apparatus that image capturing is being performed, when performing image capturing based on the biometric information of the photographer.

26. The photographing apparatus according to claim 17, comprising a biosensor that detects the biometric information of the photographer.

27. The photographing apparatus according to claim 17, wherein
the control section begins image capturing preparation in response to output of biometric information from the biosensor,

28. The photographing apparatus according to claim 17, comprising a switch that instructs the photographing section to perform image capturing, wherein
prior to image capturing based on the instructions of the switch, the control section performs image capturing based on the biometric information of the photographer.

29. An image capturing apparatus, comprising:
an image capturing section that is capable of capturing a moving image and a still image; and
a control section that is connected to a detection apparatus detecting camera shake, performs a first camera shake control corresponding to the moving image, and performs a second camera shake control, which differs from the first camera shake control, corresponding to the still image, wherein
the control section changes between the first camera shake control and the second camera shake control according to change in biometric information of a photographer detected by a biosensor.

30. The image capturing apparatus according to claim 29, wherein
the control section changes detection sensitivity of the detection apparatus when the image capturing section captures the still image.

31. The image capturing apparatus according to claim 29, wherein
the control section changes an amplitude value of a camera shake correction when the image capturing section captures the moving image.

32. The image capturing apparatus according to claim 29, wherein
image capturing by the image capturing section is performed through an optical system, and
the control section performs camera shake control by using a first correcting section that corrects camera shake using a portion of the optical system together with a second correcting section that differs from the first correcting section.

33. An image capturing apparatus comprising:
an image capturing section that is capable of capturing a moving image and a still image using an optical system; and
a control section that is connected to a detection apparatus detecting camera shake, wherein
the control section performs camera shake control by using a first correcting section that corrects camera shake using a portion of the optical system together with a second correcting section that differs from the first correcting section, according to change in biometric information of a photographer detected by a biosensor.

34. An image capturing apparatus comprising:
an image capturing section that captures an image;
a changing section that is capable of changing a setting of a detection apparatus detecting camera shake; and
a control section that changes the setting of the detection apparatus by controlling the changing section, according to change in biometric information of a photographer detected by a biosensor.

35. The image capturing apparatus according to claim 34, wherein
the control section changes detection sensitivity of the detection apparatus.

36. The image capturing apparatus according to claim 34, wherein
the image capturing section includes a shutter that controls image capturing time, and
the changing section shortens the image capturing time by controlling the shutter, according to change in the biometric information of the photographer detected by the biosensor.

37. An image capturing apparatus comprising:
an image capturing section that captures an image; and
a control section that is connected to a detection apparatus detecting camera shake, wherein
the control section corrects camera shake detected by the detection apparatus to have an amplitude exceeding a prescribed value, according to change in biometric information of a photographer detected by a biosensor.

38. The image capturing apparatus according to claim 37, wherein
the control section increases a frame rate when the image capturing section captures a moving image, according to change in the biometric information of the photographer detected by the biosensor.

39. The image capturing apparatus according to claim 37, comprising a sound recording apparatus that records sound with a set gain, wherein
the control section changes the gain according to change in the biometric information of the photographer detected by the biosensor.

40. A personal device comprising:
an operating section that is operated by a user; and
a prohibiting section that prohibits execution of a portion of the operation performed on the operating section, when a change in biometric information of the user is detected by a biosensor.

41. The personal device according to claim 40, wherein
the operating section includes a power supply switch that is operated to turn a power supply ON and OFF, and
the prohibiting section prohibits the power supply switch from turning the power supply OFF when change is detected in the biometric information of the user by the biosensor.

42. The personal device according to claim 40, comprising an image capturing section that captures an image, wherein
the operating section includes a deleting section that is operated to delete the image captured by the image capturing section, and
the prohibiting section prohibits the image from being deleted when change is detected in the biometric information of the user by the biosensor.

43. The personal device according to claim 42, comprising an editing section that edits the image captured by the image capturing section, wherein
the operating section includes an editing section that is used to operate the editing section of the personal device, and
the prohibiting section prohibits the editing section from performing editing when change is detected in the biometric information of the user by the biosensor.

44. The personal device according to claim 40, wherein
the prohibiting section permits prohibited operations to be performed when the operating section is operated a plurality of times.

45. The personal apparatus according to claim 40, comprising:
a display section that performs display; and
a control section that provides a display indicating how level the personal device is within the display section when change in the biometric information of the user is detected.
